(19) United States
(12) Patent Application Publication
(10) Pub. No.: US 2010/0134487 A1
(43) Pub. Date: Jun. 3, 2010

(54) 3D FACE MODEL CONSTRUCTION METHOD

(76) Inventors: Shang-Hong Lai, Hsinchu (TW); Shu-Fan Wang, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/349,190

(22) Filed: Jan. 6, 2009

(30) Foreign Application Priority Data
Dec. 2, 2008 (TW) 97146819

(51) Int. Cl. G06T 15/00; G06K 9/36

(52) U.S. Cl. 345/419; 382/285

(57) ABSTRACT

A 3D face model construction method is disclosed herein, which includes a training step and a face model reconstruction step. In the training step, a neutral shape model is built from multiple training faces, and a manifold-based approach is proposed for processing 3D expression deformation data of training faces in 2D manifold space. In the face model reconstruction step, first, a 2D face image is entered and a 3D face model is initialized. Then, texture, illumination and shape of the model are optimized until error converges. The present invention enables reconstruction of a 3D face model from a single face image, reducing the complexity for building the 3D face model by processing high dimensional 3D expression deformation data in a low dimensional manifold space, and removal or substituting an expression by a learned expression for the reconstructed 3D model built from the 2D image.

### BACKGROUND OF THE INVENTION

1. Field of the Invention

The present invention relates to a 3D face model construction method, particularly a method which can reconstruct a 3D face model with the associated expressional deformation from a single 2D face image with facial expression.

2. Description of the Related Art

Facial recognition technology is one of the popular researches in the field of computer image and biometric recognition. The main challenge of 2D facial recognition is the varying facial expressions under different poses. To overcome such problem, many developed algorithms require enormous amount of training data under different head poses. However, in practice, it is fairly difficult to collect 2D face images under accurate head pose.

Recently, constructing a 3D face model from images is a very popular topic with many applications, such as facial animation and facial recognition, etc. Model-based statistical techniques have been widely used for robust human face modeling. Most of the previous 3D face reconstruction techniques require more than one face image to achieve satisfactory 3D human face modeling. Another approach for 3D face reconstruction from a single image is to simplify the problem by using a statistical head model as the priori. However, it is difficult to accurately reconstruct the 3D face model from a single face image with expression since the facial expression induces 3D face model deformation in a complex manner.

### SUMMARY OF THE INVENTION

To solve aforementioned problems, one objective of the present invention is to propose a 3D human face construction method which can reconstruct a complete 3D face model from a single face image with expression deformation.

One objective of the present invention is to propose a 3D human face model construction method based on the probabilistic non-linear 2D expression manifold learned from a large set of expression data to decrease the complexity in constructing a face model.

In order to achieve abovementioned objective, one embodiment of the present invention discloses a 3D human face construction method comprising first, conducting a training step which includes registering and reconstructing data of a plurality of training faces to build a 3D neutral shape model, and calculating a 3D expression deformation for each expression of each said training face and projecting it onto a 2D expression manifold and calculating a probability distribution of expression deformations simultaneously. Next, conducting a face model reconstructing step comprising entering a 2D face image and obtaining a plurality of feature points from said 2D face image, conducting an initialization step for a 3D face model based on said feature points, conducting an optimization step for texture and illumination, conducting an optimization step for shape, and repeating optimization steps for texture and illumination and for shape until error converges;

### BRIEF DESCRIPTION OF THE DRAWINGS

The objectives, technical contents and characteristics of the present invention can be more fully understood by reading the following detailed description of the preferred embodiments, with reference made to the accompanying drawings, wherein:

FIG. 1 is a flowchart of the 3D human face construction method according to one embodiment of the present invention;

FIG. 2a-FIG. 2d are diagrams showing a generic 3D morphable face model according to one embodiment of the present invention;

FIG. 3 is a low-dimensional manifold representation of expression deformations; and

FIG. 4 shows the experimental results of one embodiment of the present invention.

### DETAILED DESCRIPTION OF THE INVENTION

The present invention proposes a method which can reconstruct a 3D human face model from a single face image. This method is based on a trained 3D neutral shape model and a probabilistic 2D expression manifold model. The complexity of the 3D face model can be reduced by lowering the dimensions based on a manifold approach when processing the training data. In addition, an iterative algorithm is used to optimize the deformation parameters of the 3D face model.

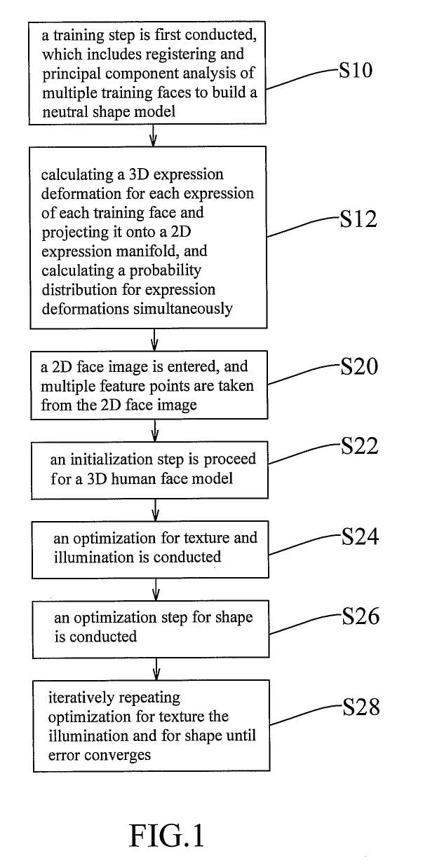

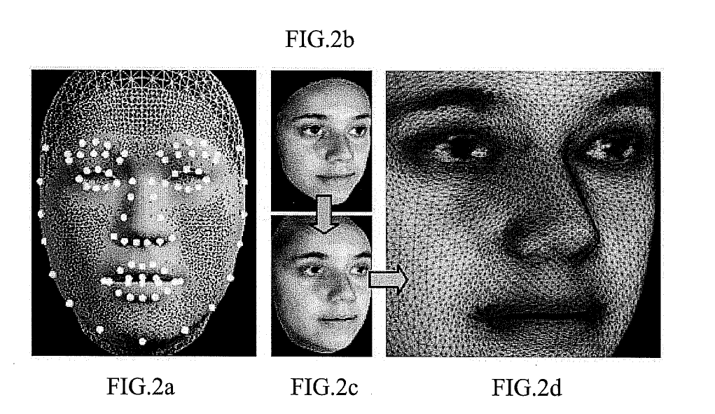

The flowchart to construct the 3D model of one embodiment of the present invention is shown in FIG. 1. This embodiment uses human face reconstruction as an example, but it can also be applied to recognition of figures of similar geometry or similar images. In this embodiment, a training step is first conducted, which includes registering and reconstructing data of multiple training faces to build a neutral shape model (step S10). In this embodiment, the neutral shape model is a neutral face model. One embodiment for building the 3D neutral shape model includes registering a plurality of feature points from each training face, re-sampling, smoothing and applying principal component analysis (PCA). As an example for this embodiment, we uses 83 feature points for each face scan as the data of training faces, as shown in FIG. 2a, obtained from BU-3DFE(Binghamton University 3D facial expression) database. Please referring to FIG. 2a to FIG. 2d, FIG. 2a shows a plurality of feature points taken from a common face model; FIG. 2b is the original face scan; FIG. 2c is the model after registration, re-sampling and smoothing; and FIG. 2d shows the triangulation detail after processing.

The next training step of the embodiment shown in FIG. 1 is calculating a 3D expression deformation for each expression of each training face and projecting it onto a 2D expression manifold, and calculating a probability distribution for expression deformations simultaneously (step S12). In one embodiment of the present step, we employ locally linear embedding (LLE) to achieve low-dimensional non-linear embedding of facial deformations of the feature points on each training face Δsᵢ^{fp}, which can be calculated as:

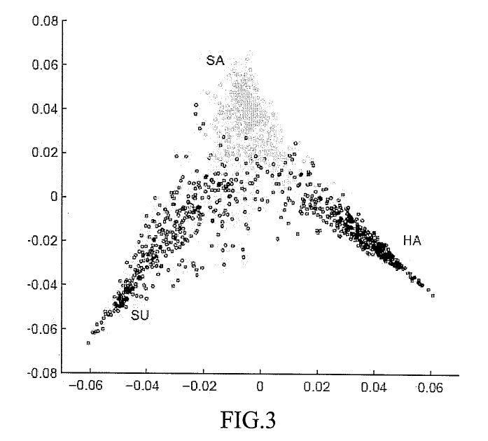

Δsᵢ^{fp}=S_{Ei}^{fp}−S_{Ni}^{fp} Δsᵢ^{fp}=S_{Ei}^{fp}−S_{Ni}^{fp} (1)

wherein S_{Ei}^{fp}={x₁^{E},y₁^{E},z₁^{E}, . . . xₙ^{E},yₙ^{E},zₙ^{E}}∈ [symbol] denotes the iₜₕ 3D face geometry with expression and S_{Ni}^{fp} denotes the iₜₕ 3D neutral face geometry. M 3D expression deformations Δsᵢ^{fp} for i=1 . . . M are projected onto a 2D expression manifold, as shown in FIG. 3. These data includes different magnitude, content and styles of expressions. In order to represent the distribution of different expression deformations, in one embodiment, we uses Gaussian mixture model (GMM) to approximate the probability distribution the 3D expression deformations in the low-dimensional expression manifold, as shown in expression (2):

$${P}_{GMM} ( {s}^{LLE} ) = {\sum }_{c = 1}^{C} {ω}_{c} N ( {s}^{LLE} ; {μ}_{c} , {\sum }_{c}^{ } ) \qquad ( 2 )$$

wherein s^{LLE} is the projected 3D expression deformation onto 2D expression manifold by locally linear embedding(LLE), ω_{c} is the probability of being in cluster C, and 0<ω_{c}<1,

$${\sum }_{c = 1}^{C} {ω}_{c} = 1 ,$$

and μ_{c} and

$${\sum }_{c}$$

denotes the mean and covariance matrix of the cₜₕ Gaussian distribution. The expectation maximization (EM) algorithm is employed to compute the maximum likelihood estimation of the model parameters.

In continuation of the aforementioned description, based on the trained 3D neutral shape model and the 2D expression manifold model, we proceed to reconstructing a human face model. First in face reconstruction steps, a 2D face image of unknown expression is entered, and multiple feature points are taken from the 2D face image (step S20). Then, we analyze the magnitude of the expression deformation to obtain the weighting of vertex in the 3D neutral shape model. In one embodiment, we quantify deformation of each vertex in the original 3D space to measure the magnitude of deformation. As shown in FIG. 3, the distribution shows relative magnitude of expression deformations. In this embodiment, three expressions, happy (HA), sad (SA) and surprise (SU) are shown as an example, and the unified magnitude vector is obtained by calculating the combination of the magnitudes from different expressions. According to the abovementioned statistics of the magnitude of the expression deformation, we can determine the weighting of each vertex in the 3D neutral shape model. Therefore, the weighting for each 3D vertex j for a neutral shape geometry model, denoted by ωⱼ^{N} is defined as:

$${ω}_{j}^{N} = \frac{{mag}_{max} - {mag}_{j}}{{mag}_{max} - {mag}_{min}} \qquad ( 3 )$$

wherein magₘₐₓ, magₘᵢₙ and magⱼ denote maximal, minimal, and the jₜₕ vertex's deformation magnitude, respectively.

Next, we proceed to an initialization step for the 3D human face model (step S22). We estimate a shape parameter vector α by minimizing the geometric distances of feature points, as shown in expression (4):

$${min}_{f , t , α} {\sum }_{j = 1}^{n} {ω}_{j}^{N} ‖ {u}_{j} - ( Pf {\hat{x}}_{j} ( α ) + t ) ‖ \qquad ( 4 )$$

wherein definition of ωⱼ^{N} is described above, μⱼ denotes the coordinate of the jₜₕ feature point of the 2D face image, P is the orthographic projection matrix, f is the scaling factor, R is the 3D rotation matrix, t is the translation vector and \hat{x}ⱼ(α) denotes the jₜₕ reconstructed 3D feature point, which is determined by the shape parameter vector α as in expression (5):

$${\hat{x}}_{j} = {\overline{x}}_{j} + {\sum }_{l = 1}^{m} {α}_{l} {s}_{l}^{j} \qquad ( 5 )$$

In one embodiment, the aforementioned minimization problem can be solved by using the Levenberg-Marquardt optimization to find the 3D face shape parameter vector and the pose of the 3D face as the initial solution for the 3D face model. In this step, the 3D neutral shape model is initialized and the effect of the deformation from facial expression can be alleviated by using the weighting ωⱼ^{N}. Since the magnitude, content and styles of expressions are all embedded into the low-dimensional expression manifold, the only parameters for facial expression are the coordinate of s^{LLE}, and in one embodiment, the initial s^{LLE} is set to (0,0.01), which is located at the common border of different expressions on the expression manifold.

In continuation, after the initialization step, all parameters are iteratively optimized in two steps. The first step includes an optimization for texture and illumination (step 24), which requires estimating a texture coefficient vector β and determine illumination bases B and the corresponding spherical harmonic (SH) coefficient vector [symbol] . The illumination bases B are determined by a surface normal n and texture intensity T(β). Texture coefficient vector β and SH coefficient vector [symbol] can be determined by solving the following optimization problem:

$${min}_{β , l} ‖ {I}_{input} - B ( T ( β ) , n ) ‖ \qquad ( 6 )$$

In continuation of the abovementioned description, two areas—face feature area and skin area—of different reflection properties are defined for more accurate texture and illumination estimation. Since the feature area is less sensitive to illumination variations, the texture coefficient vector β is estimated based on minimizing the intensity errors for the vertices in the face feature area. On the other hand, the SH coefficient vector [symbol] is determined by minimizing the image intensity errors in the skin area.

The second step includes an optimization step for shape (step S26). The facial deformation is estimated from the photometric approximation with the estimated texture parameters obtained from the previous step. In one embodiment, we employ a maximum a posteriori (MAP) estimator which finds the shape parameter vector α, an estimated expression parameter vector ŝ^{LLE} and a pose parameter vector ρ={f,R,t} by maximizing a posterior probability expressed as follows:

$$\begin{matrix}p ( α , ρ , {\hat{s}}^{LLE} \vert {I}_{input} , β ) ∝ p ( {I}_{input} \vert α , β , ρ , {\hat{s}}^{LLE} ) \cdot p ( α , ρ , {\hat{s}}^{LLE} ) \approx exp ( \frac{- {‖ {I}_{input} - {I}_{exp} ( α , β , ρ , {\hat{s}}^{LLE} ) ‖}^{2}}{2 {σ}_{I}^{2}} ) \cdot p ( α ) \cdot p ( ρ ) \cdot p ( {\hat{s}}^{LLE} ) \approx exp ( \frac{- {‖ {I}_{input} - {I}_{exp} ( α , β , ρ , {\hat{s}}^{LLE} ) ‖}^{2}}{2 {σ}_{I}^{2}} ) \cdot p ( α ) \cdot p ( ρ ) \cdot p ( {\hat{s}}^{LLE} ) & ( 7 )\end{matrix}$$

with

Iₑₓₚ(α,β, f,R,t,ŝ^{LLE})=I(fR(S(α)+φ(ŝ^{LLE}))+t) (8)

wherein ρ_{I} is the standard deviation of the image synthesis error and ψ(ŝ^{LLE}): [symbol] → [symbol] is a non-linear mapping function that maps the estimated ŝ^{LLE} from the embedded space with dimension e=2 to the original 3D deformation space with dimension 3N. The nonlinear mapping function is of the following form:

$$ψ ( {\hat{s}}^{LLE} ) = {\sum }_{k ∈ NB ( {\hat{s}}^{LLE} )}^{ } {ω}_{k} Δ {s}_{k} \qquad ( 9 )$$

wherein NB(ŝ^{LLE}) is the set of nearest neighbor training data points to said expression parameter vector ŝ^{LLE} on said 2D expression manifold, Δsₖ is the 3D deformation vector for the kₜₕ facial expression data in the corresponding set of expression deformation data of training faces, and the weight ωₖ is determined from the neighbors as described in LLE.

Since the prior probability of ŝ^{LLE} in the expression manifold is given by the Gaussian mixture model P_{GMM}(ŝ^{LLE}) and the shape parameter vector α is estimated by PCA analysis, maximizing the log-likelihood of the posterior probability in Eq.(7) is equivalent to minimizing the following energy function:

$$max ( ln p ( α , ρ , {\hat{s}}^{LLE} \vert {I}_{input} , β ) ) \approx min ( \begin{matrix}\frac{{‖ {I}_{input} - {I}_{exp} ( α , β , ρ , {\hat{s}}^{LLE} ) ‖}^{2}}{2 {σ}_{I}^{2}} + \\ {\sum }_{i = 1}^{m} \frac{{α}_{i}^{2}}{2 {λ}_{i}} - ln p ( ρ ) - ln {P}_{GMM} ( {\hat{s}}^{LLE} )\end{matrix} ) \qquad ( 10 )$$

wherein λᵢ denotes the iₜₕ characteristic value estimated with PCA analysis for 3D neutral shape model. Then, iteratively repeating optimization for texture the illumination and for shape until error converges (step S28). Besides, since the probability distribution for an expression deformation and the associated expression parameter can be estimated for each input 2D face image, the expression can be removed to produce the corresponding 3D neutral expression model. Also, other expressions from the training data can be applied.

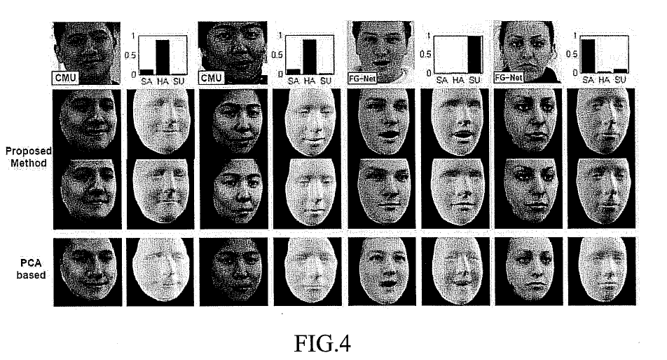

The experimental results of one embodiment of the present invention is shown in FIG. 4. The first row shows the input 2D face images and the bar graphs of the estimated probabilities for the expression modeling on the learned manifold. The second and third row represents the results including the final reconstructed expressive face models and those after expression removal. The bottom row shows the results from the traditional PCA-based method.

Based on the above description, one characteristic of the present invention is being able to remove the expression of a reconstructed 3D face model by estimating the probability distribution of the expression deformation and the expression parameter of each input 2D face image. Besides, other expressions from the training data can be applied to the reconstructed 3D face model, which is of many applications. In conclusion, the present invention discloses a 3D human face reconstruction method which can reconstruct a complete 3D face model with expression deformation from a single face image. Besides, the complexity for building a 3D face model is reduced by building a probabilistic non-linear manifold for learning from a large amount of expression training model data.

The embodiments described above are to demonstrate the technical contents and characteristics of the preset invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A 3D human face model construction method comprising:
conducting a training step comprising:
registering and reconstructing data of a plurality of training faces to build a 3D neutral shape model; and
calculating a 3D expression deformation for each expression of each said training face and projecting it onto a 2D expression manifold and calculating a probability distribution of expression deformations simultaneously; and
conducting a face model reconstructing step comprising:
entering a 2D face image and obtaining a plurality of feature points from said 2D face image;
conducting an initialization step for a 3D face model based on said feature points;
conducting an optimization step for texture and illumination;
conducting an optimization step for shape; and
repeating said optimization step for texture and illumination and
said optimization step for shape until error converges;

2. The 3D human face construction method according to claim 1, wherein said 2D expression manifold employs locally linear embedding (LLE) which expresses an expression deformation of each said training face as Δsᵢ^{fp}=S_{Ei}^{fp}−S_{Ni}^{fp}, wherein S_{Ei}^{fp}={x₁^{E},y₁^{E},z₁^{E}, . . . xₙ^{E},yₙ^{E},zₙ^{E}}∈ [symbol] is a set of feature points of the iₜₕ 3D face geometry with facial expression, and S_{Ni}^{fp} denotes a set of feature points of the iₜₕ neutral face geometry.

3. The 3D human face construction method according to claim 2, wherein said probability distribution of expression deformations is approximated by a Gaussian Mixture Model (GMM) as:
$${P}_{GMM} ( {s}^{LLE} ) = {\sum }_{c = 1}^{C} {ω}_{c} N ( {s}^{LLE} ; {μ}_{c} , {\sum }_{c}^{ } ) ,$$
wherein s^{LLE} is the projected 3D expression deformation onto 2D expression manifold by said locally linear embedding(LLE), ω_{c} is the probability of being in cluster C and 0<ω_{c}<1,
$${\sum }_{c = 1}^{C} {ω}_{c} = 1 ,$$
and μ_{c} and
$${\sum }_{c}^{ }$$
are the mean and covariance matrix for the Cₜₕ Gaussian distribution respectively.

4. The 3D human face construction method according to claim 3, wherein said initialization step comprises estimating a shape parameter vector α by solving the following minimization problem:
$${min}_{f , t , α} {\sum }_{j = 1}^{n} {ω}_{j}^{N} ‖ {u}_{j} - ( Pf {\hat{x}}_{j} ( α ) + t ) ‖ ,$$
wherein ωⱼ^{N} is the weighting of the jₜₕ 3D vertex for said 3D neutral shape model, μⱼ denotes the coordinate of the jₜₕ feature point in said 2D face image, P is the orthographic projection matrix, f is the scaling factor, R is the 3D rotation matrix, t is the translation vector and \hat{x}ⱼ(α) denotes the jₜₕ reconstructed 3D feature point.

5. The 3D human face construction method according to claim 4, wherein ωⱼ^{N} is defined as:
$${ω}_{j}^{N} = \frac{{mag}_{max} - {mag}_{j}}{{mag}_{max} - {mag}_{min}} ,$$
wherein magₘₐₓ, magₘᵢₙ, magⱼ denote maximal, minimal and the jₜₕ vertex's deformation magnitudes, respectively.

6. The 3D human face construction method according to claim 4, wherein \hat{x}ⱼ(α) is determined by said shape parameter vector α as follows:
$${\hat{x}}_{j} = {\overline{x}}_{j} + {\sum }_{l = 1}^{m} {α}_{l} {s}_{l}^{j} .$$

7. The 3D human face construction method according to claim 4, wherein said optimization step for texture and illumination comprises estimating a texture coefficient vector β and determining illumination bases B and a corresponding spherical harmonic (SH) coefficient vector [symbol] wherein said illumination bases B are determined by a surface normal n and texture intensity T(β), and said texture coefficient vector β and said SH coefficient vector [symbol] can be estimated by solving the following optimization problem:
$${min}_{β , l} ‖ {I}_{input} - B ( T ( β ) , n ) ‖ .$$

8. The 3D human face construction method according to claim 7, wherein said optimization step for shape comprises:
employing a maximum a posteriori (MAP) estimator which finds said shape parameter vector α, an estimated expression parameter vector ŝ^{LLE} and a pose parameter vector ρ={f,R,t} by maximizing a posterior probability expressed as follows:
$$p ( α , ρ , {\hat{s}}^{LLE} \vert {I}_{input} , β ) ∝ p ( {I}_{input} \vert α , β , ρ , {\hat{s}}^{LLE} ) \cdot p ( α , ρ , {\hat{s}}^{LLE} ) \approx exp ( \frac{- {‖ {I}_{input} - {I}_{exp} ( α , β , ρ , {\hat{s}}^{LLE} ) ‖}^{2}}{2 {σ}_{I}^{2}} ) \cdot p ( α ) \cdot p ( ρ ) \cdot p ( {\hat{s}}^{LLE} ) ,$$
with Iₑₓₚ(α,β,f,R,t,ŝ^{LLE})=I(fR(S(α)+φ(ŝ^{LLE}))+t),
wherein ρ_{I} is the standard deviation of the image synthesis error and ψ(ŝ^{LLE}): [symbol] → [symbol] is a non-linear mapping function.

9. The 3D face model construction method according to claim 8, wherein said non-linear mapping function ψ(ŝ^{LLE}) is of the following form:
$$ψ ( {\hat{s}}^{LLE} ) = {\sum }_{k ∈ NB ( {\hat{s}}^{LLE} )}^{ } {ω}_{k} Δ {s}_{k} ,$$
wherein NB(ŝ^{LLE}) is the set of nearest neighbor training data points to said expression parameter vector ŝ^{LLE} on said 2D expression manifold, Δsₖ is the 3D deformation vector for the kₜₕ facial expression data in the corresponding set of expression deformation data of said training faces, and the weight ωₖ is determined from the neighbors described in said LLE.
